(19) United States
(12) Patent Application Publication
(10) Pub. No.: US 2004/0264519 A1
(43) Pub. Date: Dec. 30, 2004

(54) Filter bypass method and system for chiller loop to control purity levels

(76) Inventor: John Alan Morrell, Tewksbury, MA (US)

Correspondence Address: Agfa Corporation, Law & Patent Department, 200 Ballardvale Street, Wilmington, MA, 01887-1069, US

(21) Appl. No.: 10/602,514

(22) Filed: Jun. 24, 2003

(51) Int. Cl. H01S 3/04

(52) U.S. Cl. 372/35; 372/34

(57) ABSTRACT

A cooling system for an imaging device having a light source for exposing a media in which the cooling system comprises a filter for purifying coolant flowing through the cooling system and a filter bypass for limiting the purity of the coolant. In this way, the coolant, such as water, is prevented from becoming too pure, such that it begins to attack or etch the metal components in the coolant loop in the cooling system. This problem typically arises in the closed loop DI-filtered systems is that the water coolant becomes too pure. It is known that if water becomes more pure than approximately 10 MegaOhms (MΩ), referring to the water's resistance to electrical current which increases with increasing purity, the water can actually begin to etch metal such as copper in copper pipes of the loop.

### BACKGROUND OF THE INVENTION

Imagesetters and platesetters are used to expose substrates, which are used in many conventional offset printing systems. Imagesetters are typically used to expose the film that is then used to make the plates for the printing system. Platesetters are used to directly expose the plates.

For example, plates are typically large substrates that have been coated with photosensitive or thermally-sensitive material layers, referred to the emulsion. For large run applications, the substrates are fabricated from aluminum, although organic substrates, such as polyester or paper, are also available for smaller runs.

Computer-to-plate printing systems are used to render digitally stored print content onto these printing plates. Typically, a computer system is used to drive an imaging engine of the platesetter. In a common implementation, the plate is fixed to the outside or inside of a drum and then scanned with a modulated laser source in a raster fashion.

The imaging engine selectively exposes the emulsion that is coated on the plates. After this exposure, the emulsion is developed so that, during the printing process, inks will selectively adhere to the plate's surface to transfer the ink to the print medium.

The imaging engines of these platesetters and/or imagesetters have imaging devices that generate powerful spatially and/or temporally modulated optical signals. These optical signals are used to expose the plate or film media held on the drum. Typically, the media is held on a drum that is rotated underneath the imaging engine while the imaging engine is scanned axially along the drum to expose the media on the drum.

Throughput is a critical metric for these commercial production machines. One factor limiting the speed at which they run is the power of the optical signal output from the imaging device. The more powerful the optical signal, the faster the media can be exposed.

Because they are run at such high powers, it is common to provide liquid cooling. Specifically, the lasers and modulators, in the imaging devices, are provided with water jackets or cold plates, for example, and then, a coolant is flowed through these structures in order to remove the heat to prevent excessive heat build up in these devices. The heat is then removed from the coolant in a subsequent chiller. The coolant is often water.

### SUMMARY OF THE INVENTION

The chiller coolant loops are often closed loop systems. Water evaporation is minimal since the loops are typically run at relatively low temperatures. Thus, it is only infrequently necessary to add water to these coolant loops.

In order to ensure the long term operation of the cooling jackets, the water in the closed loop coolant systems is filtered. This is especially necessary when diode-based laser sources and MEMS-based modulators are used. They have relatively small water conduits through the cooling jackets in order to facilitate circulation and distributed cooling. These holes can become easily clogged with even very fine particles in the coolant. As a result, it is common to provide particle filters to remove large particles that may enter the coolant at the chiller, for example. In addition to filtering water, de-ionizing (DI) filters are used to further increase the purity of the water coolant. Increasing the purity of the water improves the life of the water jacket and is a deterrent to algae growth in the water.

One problem that arises, however, in these closed loop DI-filtered systems is that the water coolant can actually become too pure. It is known that if water becomes more pure than approximately 10 MegaOhms (MΩ), referring to the water's resistance to electrical current which increases with increasing purity, the water can actually begin to etch metal such as copper in copper pipes of the loop. This etching has been observed in coolant loops after extended operation as the water is constantly recirculated through the DI filter and continually made more pure, beyond the purity dictated by the filter's specifications.

In general, according to one aspect, the invention features a cooling system for an imaging device. The imaging device comprises a light source for exposing a media. Specifically, the cooling system comprises a filter for purifying coolant flowing through the cooling system and a filter bypass for limiting the purity of the coolant. In this way, the coolant, such as water, is prevented from becoming too pure, such that it begins to attack or etch the metal components in the coolant loop in the cooling system.

In the preferred embodiment, the imaging device comprises a laser source and a modulator for selectively exposing a media. The media is typically a plate or film as used in offset printing systems.

The cooling system further comprises a chiller for removing heat from the coolant. A circulating pump is also provided to move the coolant through the chiller loop of the cooling system.

In the preferred embodiment, a valve is provided in the filter bypass for controlling the flow of rate of coolant through the bypass. Preferably, a dole valve is used, which provides a relatively stable flow rate of coolant across a large pressure range.

In general, according to another aspect, the invention features a method for controlling purity of a coolant in a cooling system for an imaging device. The method comprises purifying coolant flowing in the cooling system and partially bypassing a filter to limit the purity of the coolant.

In general, according to still another aspect, the invention features a filter with a bypass. This filter comprises a canister for containing a filter media. A canister cover is also provided that provides an inflow port for providing coolant from an input line into the canister and an outflow port for conveying coolant out of the canister to an output line. According to the invention, a bypass is further provided for allowing coolant to flow from the input line to the output line, bypassing a filter media in the canister. In the preferred embodiment, a valve is provided in the bypass for controlling a flow of coolant through the bypass.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a schematic block diagram of a cooling system, according to the invention, for an imaging device of an imaging engine for a platesetter for an imagesetter; and

FIG. 2 is a side plan view of an inventive canister cover for a canister filter, providing the inventive bypass.

### DETAILED DESCRIPTION OF THE PREFERRED EMBODIMENTS

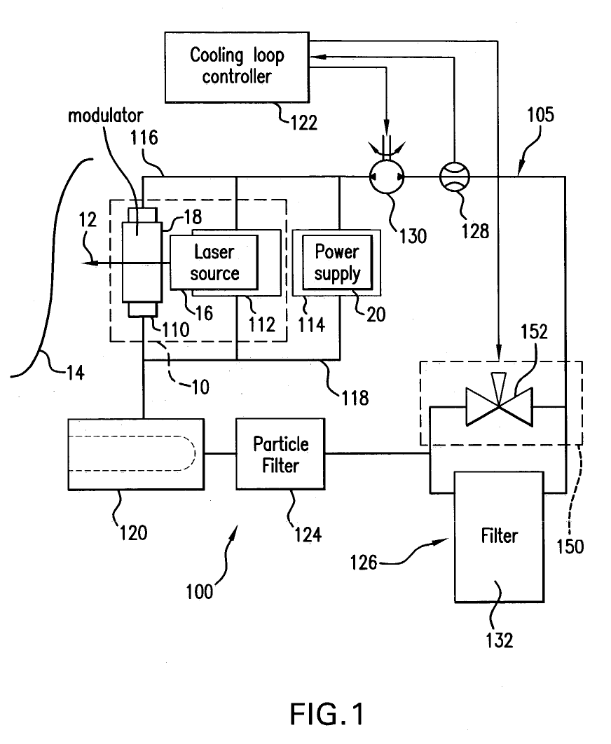

FIG. 1 shows a cooling system for an imaging device, which has been constructed according to the principles of the present invention.

In more detail, an imaging device 10 is provided, which generates a temporally and/or spatially modulated optical signal 12. This optical signal 12 is used to selectively expose the surface of media 14. In the present embodiment, the media is a plate or film as used in an offset printing system.

In the present embodiment, the imaging device generates the optical signal 12 using a combination of a source, and specifically, a laser source 16 and a spatial light modulator 18. Specifically, the laser source 112 can be implemented as a solid state laser, a diode laser, or a diode laser array. In the present embodiment, a diode laser array is used that generates a rectangular beam, which is spatially modulated by a gradient light valve (GLV) modulator 18. This GLV modulator 18 spatially modulates the light in order to selectively expose the media 14 according to received image data.

A power supply 20 is also provided to power the laser source 16. In one configuration, a separate power supply provides power to the GLV.

Each of the modulator 18, laser source 16, and power supply 20 are provided with respective cool plates or water jackets 110, 112, 114, respectively. These separate coolant devices or jackets are used to remove heat that is generated in the modulator 18, laser source 16, and power supply 20 to ensure that the devices can be run at high power while preventing any sort of excessive heat build up that could lead to improper operation or catastrophic failure produced by thermal run away.

Typically, the laser source 16 requires a certain purity level of the coolant. This is primarily due to the fact that the cooling jackets 112 have relatively small holes or ducts for the coolant to flow through the cooling jacket 112. For example, in one present example, the coolant holes are approximately 50 micrometers in diameter. Thus, small particles or other impurities such as minerals in the water can cause these small holes to clog over time if the required purity levels are not maintained.

Coolant is provided to each of the cooling jackets 112, 110, 114 via an input manifold 116. Coolant is carried away from the cooling jackets 110, 112, 114 via an output manifold 118. The output manifold carries the coolant to a chiller 120. This removes the heat from the coolant flowing in the chiller loop 105 of the cooling system 100.

This chiller 120 is typically controlled by a cooling loop controller 122, which controls the chiller 120 to remove heat from the coolant such that the temperature of the coolant exiting from the chiller 120 is maintained at a stable temperature.

Downstream of the chiller 120 is a particle filter 124. This particle filter is used to remove any relatively large particles that could enter into the coolant loop from the chiller 120, for example. In the present example, the particle filter 124 is a 5 micrometer filter, such that it can remove particles as small as 5 micrometers in size. The particle filter 124, however, cannot maintain an adequate level of purity of the coolant as is typically required by the laser source 112 and its respective water jacket 112. In a present example, the cooling jacket 112 of the laser source 116 requires a water coolant purity of greater than 250 kiloOhms (kΩ). This requires the addition of a di-ionizing (DI) filter 126 to the chiller loop 105.

In the present example, the DI filter 126 is a 1 MΩ filter to ensure that the water in the chiller loop 105 is of sufficient purity to ensure the long life of the laser source 16. Water at the 250 kiloOhms (KΩ) purity level deters algae growth and decreases the frequency of water changes in the closed loop cooling system.

A flow sensor 128 is further provided in the chiller loop 105. This provides coolant flow information to the cooling loop controller 122 to ensure proper operation. Further, a loop pump 130 is provided to move the water coolant through the chiller loop 105 of the cooling system 100.

According to the invention, a filter bypass 150 is provided so that a portion of the coolant bypasses the DI filter 126. Preferably, this filter bypass 150 comprises a valve 152. In one embodiment, this valve is controlled by the cooling loop controller 122. In another embodiment, the valve 152 is a dole valve that provides a relatively constant flow rate for a large range of pressure gradient across the valve.

The bypass 150 prevents the water coolant in the chiller loop from becoming too pure. For example, if the water purity exceeds 10 MΩ, pitting and etching of any copper in the chiller loop begins to take place. It has been shown that by providing the filter bypass 150 the excessive purity in the water is avoided.

The bypass 150 provides other advantages. It reduces the back pressure, which increases the life of the loop pump 130. Further, it decreases the flow of coolant through the DI filter 126 to prevent channeling in the filter material 132 contained in the DI filter 126.

In the preferred embodiment, the valve 152 is a dole valve. This provides a relatively constant flow rate, regardless of the pressure across the valve 152. In this way, the degree of bypass, and therefore, the purity of the coolant can be controlled and held at a stable level over time.

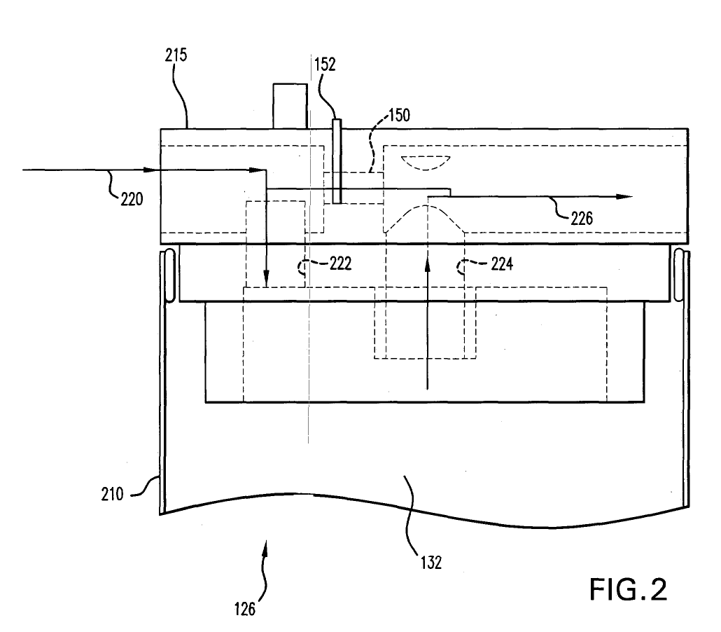

FIG. 2 shows one implementation of the DI filter 126 and bypass 150. Specifically, the DI filter comprises a canister 210 and a canister cover 215. Specifically, the canister 210 comprises the filter media 132, which purifies the coolant or water. Typically, the canister 110 is cylindrical or cup-shaped. The canister cover 215 forms a lid that is attached to the top of the canister 210, by screwing the canister cover 215 down onto the canister 210.

The canister cover comprises a water input line 220. This conveys the water or coolant into the canister cover. An inflow port 222 is provided from the input line into the filter media 132 in the canister 210. An outflow port 224 is provided for allowing the water or coolant to leave the canister 210, after having flowed through the filter media 132. Water from the outflow port enters an output line 226 to continue through the chiller loop 105.

According to the invention, the bypass 150 is provided between the water input line 220 and the water output line 226. In the preferred embodiment, this is simply a hole or a port that has been bored through the bulk material of the canister cover 215 between the water input line 220 and the water output line 226.

In the preferred embodiment, the valve 152 is inserted into this bypass port or hole 150, in order to control the flow of water between the water input line 220 and the water output line 226 of the canister cover 215.

While this invention has been particularly shown and described with references to preferred embodiments thereof, it will be understood by those skilled in the art that various changes in form and details may be made therein without departing from the scope of the invention encompassed by the appended claims.

What is claimed is:

1. A cooling system for an imaging device, the imaging device comprising a light source for exposing a media, the system comprising:
a filter for purifying a coolant flowing in the cooling system; and
a filter bypass for limiting a purity of the coolant.

2. A cooling system as claimed in claim 1, wherein the coolant is water.

3. A cooling system as claimed in claim 1, wherein the imaging device comprises a laser source and a modulator for selectively exposing a media.

4. A cooling system as claimed in claim 3, wherein the media is a plate or film for an offset printing system.

5. A cooling system as claimed in claim 1, wherein the cooling system further comprises a chiller for removing heat from the coolant.

6. A cooling system as claimed in claim 1, wherein the cooling system further comprises a circulating pump for moving the coolant through a chiller loop of the cooling system.

7. A cooling system as claimed in claim 1, wherein a chiller loop of the cooling system is a closed loop system.

8. A cooling system as claimed in claim 1, further comprising a valve in the filter bypass for controlling a flow of coolant through the filter bypass.

9. A cooling system as claimed in claim 1, wherein the valve is a dole valve providing a stable flow rate of coolant through the filter bypass.

10. A method for controlling purity of a coolant of a cooling system for an imaging device for exposing a media, the method comprising:
purifying the coolant flowing in the cooling system; and
partially bypassing a filter to limit a purity of the coolant.

11. A method as claimed in claim 10, further comprising making a coolant loop a closed loop.

12. A method as claimed in claim 10, further comprising regulating a flow of coolant bypassing the filter.

13. A method as claimed in claim 10, further comprising stabilizing a flow of coolant bypassing the filter for a range of pressures.

14. A filter with a bypass, the filter comprising:
a canister for containing a filter material; and
a canister cover including an inflow port for providing a coolant from an input line into the canister, an outflow port for conveying coolant out of the canister to an output line, and bypass for allowing coolant to flow from the input line to the output line, bypassing a filter media in the canister.

15. A filter as claimed in claim 14, further comprising a valve in the bypass for controlling a flow of coolant through the bypass.

16. A filter as claimed in claim 15, wherein the valve is a dole valve providing a stable flow rate of coolant through the bypass.

17. A filter as claimed in claim 14, wherein the bypass is formed through the canister cover.
